(19) United States
(12) Patent Application Publication
(10) Pub. No.: US 2003/0138370 A1
(43) Pub. Date: Jul. 24, 2003

(54) Polyfilamentary carbon fibers and a flash spinning process for producing the fibers

(76) Inventors: Will G. Adams, Ponca City, OK (US); Bharat S. Chahar, Ponca City, OK (US); Xiaoyi Gong, Ponca City, OK (US); Hyunkook Shin, Wilmington, DE (US)

Correspondence Address: FISH & RICHARDSON P.C., 3300 DAIN RASCHER PLAZA, 60 SOUTH SIXTH STREET, MINNEAPOLIS, MN, 55402, US

(21) Appl. No.: 10/163,031

(22) Filed: Jun. 4, 2002

Related U.S. Application Data
(60) Provisional application No. 60/296,044, filed on Jun. 5, 2001.

(51) Int. Cl. D01F 9/12; C08K 3/00; C08J 3/00; C08L 1/00

(52) U.S. Cl. 423/447.1; 423/447.2; 208/39; 524/424; 264/29.2

(57) ABSTRACT

A process for preparing fibers, including: (a) providing a spinning mixture including a dispersion of a flashing agent and an excess of a carbonaceous pitch; and (b) passing the spinning mixture from a high pressure region through an orifice to a low pressure region to form polyfilamentary pitch fibers. The pitch fibers may optionally be further treated to form polyfilamentary carbon fibers or graphite fibers, which may be incorporated into a resin to form a lightweight, conductive composite.

### CROSS-REFERENCE TO RELATED APPLICATIONS

This application claims priority from U.S. Provisional Application Ser. No. 60 296,044, filed Jun. 5, 2001.

### TECHNICAL FIELD

This invention relates to a flash spinning process for converting carbonaceous pitch into pitch fibers suitable as precursors for polyfilamentary carbon or graphite fibers. More particularly, the invention relates to a process for flash-spinning a dispersion of carbonaceous pitch into polyfilamentary pitch fibers. The pitch fibers may be stabilized all carbonized or graphitized to produce polyfilamentary carbon fibers with a low bulk density, open porosity and an irregular surface. The polyfilamentary carbon fibers may be incorporated into a matrix material to produce a lightweight, thermally and/or electrically conductive composite.

### BACKGROUND

Conventional pitch-based carbon fibers are typically made by melt or blow spinning a carbonaceous pitch. In blow spinning operations, a gas attenuates the fiber as it exits a spinning capillary, while in melt spinning a take-up roll pulls the fiber to produce a desired degree of attenuation.

As described in, for example, U.S. Pat. No. 3,081,519, flash spinning processes have been used to produce fibers from a spinning solution including a polyolefin and a solvent. In a typical flash spinning process the spinning solution is heated, pressurized, and passed through an orifice to a region of lower temperature and pressure. As the spinning solution leaves the orifice, the solvent evaporates rapidly, which produces a web-like arangment of polyolefin fibers.

In addition to the polyolefin component, the flash spinning mixture may also include a carbonaceous pitch derived from coal tar or petroleum. In U.S. Pat. No. 5,308,598, a spinning mixture is prepared that includes 7-22% by weight carbonaceous pitch, 0.3-5% by weight polyethylene, and 74.5-92.7% by weight of an organic liquid such an aliphatic or aromatic hydrocarbon. This spinning mixture is heated, placed under a pressure of at least 7000 kPa (1000 psig), and passed through an orifice into an ambient region to form a web-like pitch/polyethylene composite. The as-spun fiber includes a web-like network of strands, referred to as a plexifilamentary structure. The as-spun fibers are connected at multiple tie points along and across each strand and have a high specific surface area of at least 1.0 m²/g. The as-spun fibers are flexible and may be formed into a loop or tied in a knot. After flash spinning, the as-spun fibers may optionally be further processed by conventional carbonization and graphitization treatments.

### SUMMARY

The plexifilamentary pitch/polyethylene composite fibers described in U.S. Pat. No. 5,308,598 are made using a spinning mixture including a carbonaceous pitch, polyethylene and an excess of an aliphatic or an aromatic hydrocarbon. The polyethylene provides the spinning mixture with film-forming capabilities, which produces as-spun plexifilamentary composite fibers that retain flexibility. Graphitizing these as-spun fibers produces a fragile material that would be expected to lack the elongated mesophase domains characteristic of high tensile strength, highly conductive carbon fibers.

In one aspect, the invention is a polyfilamentary pitch, carbon or graphite fiber with a length of about 100 μm to about 5000 μm, a diameter of about 10 μm to about 100 μm, and an aspect ratio of 5:1 to 500:1. The fibers preferably have a bulk density of 0.05 to 0.5 g/cc. The polyfilamentary fibers are prepared from a flash spinning process and have a non-linear, branched, highly irregular three-dimensional morphology. These fibers are readily distinguishable from the typically cylindrical, rod-like fibers prepared by conventional (melt-spinning or blow-spinning) carbon fiber processes. The flash-spun fibers include internal voids and have a much more irregular surface than the generally smooth surfaces of conventional carbon fibers carbon fibers. However, like conventional carbon figuers, the inventive flash-spun fibers have closely packed, continuous, elongate graphitic domains.

This surface morphology improves compatability with polymeric resins and reduces the need for surface treatment of the graphitized fiber prior to compounding with the resin. The graphitized fibers derived from this spinning mixture also have a low bulk density, which provides high fiber-to-fiber contact in a resin at low loading levels. The presence of continuous, elongate graphitic domains provides a fiber network with high tensile strength and excellent thermal and electric conductivity. The thermal and electrical conductivity properties of the fibers in turn enhance the thermal or electrical conductivity of a composite material compared to that observed with conventional fibers at similar loading levels.

In a second aspect, the invention is a flash spinning mixture that may be used to make the polyfilamentary fibers. The flash spinning mixture is a dispersion of an excess of a carbonaceous pitch in a flashing agent, and preferably includes about 55% to about 99% by weight of a carbonaceous pitch and about 1% to about 45% by weight of a flashing agent. In another embodiment, the invention is a flash spinning mixture includes a dispersion of a carbonaceous pitch and an aqueous flashing agent. This flash spinning mixture include fewer volatile organic compounds and a higher precursor concentration than the spinning mixtures described in U.S. Pat. No. 5,308,598.

In a third aspect, the invention is a process for making fibers, including: (a) providing a spinning mixture including a dispersion of an excess of a carbonaceous pitch and a flashing agent; and (b) passing the spinning mixture from a high pressure region through an orifice to a low pressure region to form pitch fibers. The pitch fibers may optionally be stabilized and/or carbonized and graphitized at an appropriate temperature to form carbon fibers or graphite fibers.

In a fourth aspect, the invention is a process for making a porous film, including: (a) providing a spinning mixture including a dispersion of an excess of a carbonaceous pitch in a flashing agent; and (b) passing the spinning mixture from a high pressure region through an orifice to a low pressure region to form pitch fibers; (c) collecting the pitch fibers on a heated surface to form a mat; and (d) further treating the mat to form a porous carbon or graphite film.

In a fifth aspect, the invention is a process for making a polymeric resin, including: (a) providing a spinning mixture including a dispersion of an excess of a carbonaceous pitch in a flashing agent; (b) heating and pressurizing the spinning mixture in a high pressure region; (c) passing the spinning mixture from the high pressure region through a spinneret to a low pressure region to form pitch fibers; and (d) stabilizing and graphitizing the pitch fibers; and (e) incorporating the stabilized fibers into a polymeric resin.

In a sixth aspect, the invention is a method for enhancing the thermal conductivity of a polymeric resin, including incorporating into the resin a carbon fiber derived from a spinning mixture including a dispersion of an excess of a carbonaceous pitch and a flashing agent.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a photograph of pitch fibers of Example 1 taken with a scanning electron microscope at 20×.

FIG. 1B is a photograph of pitch fibers of Example 1 taken with a scanning electron microscope at 50×.

FIG. 2A is a photograph of pitch fibers of Example 2 taken with a scanning electron microscope at 60×

FIG. 2B is a photograph of pitch fibers of Example 2 taken with a scanning electron microscope at 1500×.

FIG. 3 is a photograph of fiber cross sections taken at 3000× showing the graphitic internal structure of the fibers of Example 2.

FIG. 4 is a graph depicting the thermal conductivity of an epoxy composite containing flash spun fibers.

FIG. 5 is a photograph of fibers of Example 4 taken with a scanning electron microscope at 180×.

FIG. 6A is a cross-sectional photographs taken with a scanning electron microscope at 1200× showing the fibers of Example 10C embedded in an epoxy resin.

FIG. 6B is a cross-sectional photograph taken with a scanning electron microscope at 1500× showing the fibers of Example 10C embedded in an epoxy resin.

FIG. 7A is a photograph of fibers of Example 14 taken with a scanning electron microscope at 35×.

FIG. 7B is a photograph of fibers of Example 14 taken with scanning electron microscope at 500×.

FIG. 8A is a photograph of a fiber of Example 10C taken with a scanning electron microscope at 180×.

FIG. 8B is a photograph of a fiber of Example 10C taken with a scanning electron microscope at 75×.

FIG. 9 is a graph depicting the thermal conductivity of a carbon filled epoxy composite material filled with polyfilamentary fibers (referred to as “fibrils”).

FIG. 10 is a schematic cut-away view of a flash spinning apparatus used in Example 9.

FIG. 11 is a photograph of a porous carbon film taken with a scanning electron microscope at 180×.

### Like reference symbols in the various drawings indicate like elements.

### DETAILED DESCRIPTION

In one aspect, the invention is a spinning mixture suitable for use in a flash spinning process for making pitch fibers suitable as precursors for carbon or graphite filers. The spinning mixture is a dispersion of an excess of a carbonaceous pitch and a flashing agent.

The carbonaceous pitch may include: (1) compounds produced as a by-product in processes for producing natural asphalt; (2) petroleum pitches and heavy oil obtained as by-products in a naptha cracking process; and (3) high carbon content pitches obtained from coal; and (4) mixtures or combinations thereof. Petroleum pitches, which include the residual carbonaceous material obtained from the catalytic and thermal cracking of petroleum distillates or residues, are preferred. The pitch may be isotropic or anisotropic or a mixture thereof, but anisotropic pitches, also referred to as mesophase forming pitches, are preferred. The mesophase forming pitches have aromatic structures that associate to form a highly oriented, optically ordered anisotropic phase.

The pitch may have a wide range of molecular weights and may be dry or solvated. Dry pitches have a solvent content of less than about 5% by weight, and typically less than about 2% by weight, based on the total weight of the pitch, as determined by weight loss on vacuum separation of the solvent. Suitable solvated pitches may be isotropic, anisotropic or mixtures thereof, and typically have a solvent content of about 5% to about 40% by weight, based on the total weight of the pitch, as determined by weight loss on vacuum separation of the solvent. Solvents used in solvated pitches include, for example, aromatic compounds with 1-5 membered ring structures such as, for example, toluene, phenanthrene and the like, as well as solvent mixtures obtained as by-products of petroleum pitch production that contain aromatic compounds with 1-4 membered rings and having a molecular weight of about 150-400. Suitable solvated pitches include those described in, for example, U.S. Pat. Nos. 5,259,947; 5,437,780; 5,540,832 and 5,501,788, as well as those available under the trade designations A 240 from Marathon Ashland Petroleum Co., Columbus, Ohio, and Mitsubishi AR from Mitsubishi Gas Chemical Co., Tokyo, Japan.

A solvated pitch has a softening or melting point (temperature at which the pitch first becomes fluid on heating at a rate of 10 to 20° C. per minute) lower than the melting point of a dry pitch with a similar molecular weight, typically at least about 40° C. lower. A spinning mixture including a solvated pitch with a particular molecular weight may typically be flash spun at a lower temperature than an otherwise identical spinning mixture including a dry pitch of that same molecular weight.

The carbonaceous pitch preferably makes up an excess of the spinning mixture (at least about 50% by weight), more preferably about 55% to about 99% by weight, based on the total weight of the spinning mixture.

The flashing agent has an atmospheric boiling point at least about 50° C. lower than the desired flash spinning temperature. Suitable flashing agents include water, polar organic solvents, alcohols, aliphatic hydrocarbons with 1-12 carbon atoms, morpholine, hydrofluorocarbons (HFCs), hydrochlorofluorocarbons (HCFCs), perfluorocarbons (PFCs), partially halogenated ethers, non-oxidizing hydrophylic compounds, carbon dioxide, ammonia, inert gases, and mixtures thereof. Water is a preferred flashing agent.

The flashing agent normally makes up less than about 50% by weight of the total weight of the spinning mixture, preferably about 1% by weight to about 45% by weight, more preferably about 3% by weight to about 45% by weight. At typical flashing temperatures of about 200-300 ° C., greater than about 3% by weight flashing agent produces an acceptable fiber yield.

The spinning mixture may optionally include a dispersing agent to enhance the association between the flashing agent and the pitch to control their miscibility and modify the homogeneity of the spinning mixture. Suitable dispersing agents include fluorinated surface active agents such as those available from 3M, St. Paul, Minn., under the trade designations FC-95+ and FC-98, polymeric dispersing agents such as ethylene/vinyl alcohol copolymers, ethylene/acid copolymers, and polyvinylalcohol (PVA), and aromatic compounds with cyclic structures that are structurally similar to the aromatic structures of the pitch molecules. The preferred dispersing agents are organic compounds with at least one, more preferably at least two, cyclic structures. Particularly preferred dispersing agents are rosins and/or tall oils that are commonly derived from the pulping of trees in paper production processes. Suitable rosins include wood rosin, gum rosin, and mixtures thereof. The useful rosins may be used in a refined or an unrefined form, but refined rosins are preferred. The rosins are typically prepared by well known procedures involving reacting rosin with acid compounds, including α, β-unsaturated monobasic and polybasic organic acids and acid anhydrides such as acrylic, maleic, fumaric, itaconic, and citraconic acids and their anhydrides. Suitable rosins include, for example, those available under the trade designation Rosin S from Westvaco Corp., Charleston Heights, S.C.

Tall oils are natural mixtures of rosin acids related to abietic acid and of fatty acids related to oleic acid, together with some non-acidic compounds. Tall oils may be used in an unfractionated form, or one or more tall oil fractions or derivatives may be used. Suitable tall oils include, for example, those available under the trade designation M-28-B from Westvaco Corp.

This enhanced homogeneity of the spinning mixture that results from the presence of the dispersing agent can have a pronounced effect upon the morphology of the pitch fibers ultimately produced in the flash spinning process. The flashing agent molecules adjacent to the pitch molecules suddenly evaporate, which suddenly distends the pitch into highly irregular polyfilamentary forms.

The dispersing agent is typically used in an amount of up to about 8% by weight, preferably up to about 4% by weight, and more preferably about 2% to 4% by weight, based on the total weight of the spinning mixture.

The spinning mixture may also optionally include one or more plasticizers. Suitable plasticizers include 1 to 4 ring aromatic solvents, related hydro- and hetero-aromatics and their 1 to 3 carbon alkyl substituted derivatives, as well as low boiling pitch solvents such as chloroform or carbon disulfide. Toluene, xylene, phenanthrene, tetralin or other solvents containing aromatic compounds are preferred plasticizers.

The plasticizer may be added to a spinning mixture to lower the flash spinning temperature. For a spinning mixture including a pitch having a certain molecular weight, the presence of the plasticizer lowers the spinning temperature. Depending on the pitch selected for use in the spinning mixture, the plasticizer is typically used in an amount up to about 20% by weight, based on the total weight of the spinning mixture.

The solvents present in solvated pitches also provide a plasticizing function in the spinning mixture. Therefore, for a pitch with a certain melting point, a spinning mixture with a solvated pitch will typically require less plasticizer, or no plasticizer, to produce pitch fibers at a given spinning temperature. However, in this application the solvent in a solvated pitch is attributed to the total weight of pitch, and is not considered part of the total weight of the plasticizer in the spinning mixture.

The spinning mixture may be used in a process for making pitch fibers suitable as precursors for carbon or graphite fibers. In this process a spinning mixture is prepared that includes greater than about 50% by weight, preferably about 55% to about 99% by weight, of a carbonaceous pitch, and less than about 50% by weight, preferably about 1% by weight to about 45% by weight, more preferably about 3% by weight to about 45% by weight, of a flashing agent. The flashing agent is added to the pitch with heating and mixing to form a dispersion. Other optional components, such as up to about 4% by weight of a dispersing agent and/or up to about 20% by weight of a plasticizer, may be added to the spinning mixture.

In preparation for spinning, the spinning mixture is heated, typically under pressure, in a flash spinning apparatus to a temperature sufficient to fluidize the components of the mixture, typically greater than the melting point of the highest melting component and the atmospheric boiling point of the flashing agent. The final temperature of the spinning mixture is preferably at least 50 ° C. greater than the atmospheric boiling point of the flashing agent. To preclude the vaporization of the flashing agent prior to spinning, the pressure within the spinning apparatus should be maintained above the autogenous pressure of the spinning mixture, the vapor pressure that results from heating the spinning mixture. A preferred pressure range is 3447 to 10342 kPa (500 to 1500 psig).

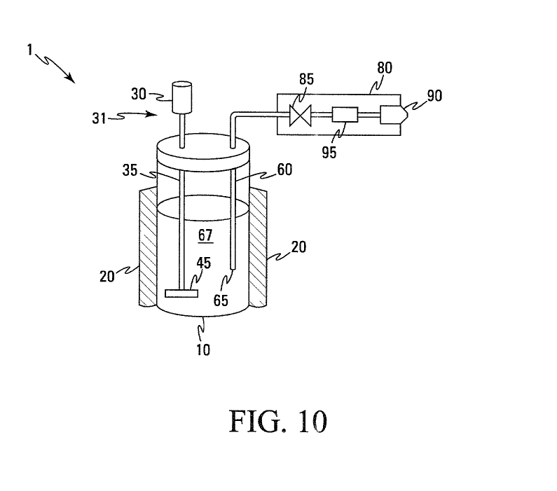

Suitable flash spinning apparatus include the twin cell device described in U.S. Pat. No. 5,023,025, incorporated herein by reference, as well as the apparatus shown in FIG. 10 of this application. Referring to FIG. 10, the apparatus 1 includes a pressure vessel 10 surrounded by a heating jacket 20. An agitator 31 includes a motor drive unit 30 and a shaft 35 extending from the drive 30 and into the interior of the vessel 10. The shaft 35 includes a flat bladed impeller 45. A fluid conduit 60 extends between the interior of the vessel 10 and the inlet side of a control block 80. An end 65 of the conduit 60 extends below the level of the spinning mixture 67, while its opposite end is connected to the control block 80 to provide a fluid conduit between the vessel 10 and the control block 80. The control block 80 includes an optional pressure control valve 85 immediately prior to the spin nozzle 90. The control block 80 also included an optional filter 95 to remove particulates and prevent fouling of the spin nozzle.

Following heating, mixing and pressurization, the spinning mixture is passed through an orifice, such as a spinneret, into a region with a much lower temperature and pressure (usually ambient temperature and pressure). The flash spinning mixtures described herein provide a very high flash spinning rate of up to 90.7 kg (200 pounds) of spinning mixture per hour per single 0.762 mm (0.030 inch) diameter spinning capillary. This corresponds to a rate of 119.3 kg (263 pounds) per hour per square millimeter of spinneret cross-sectional area.

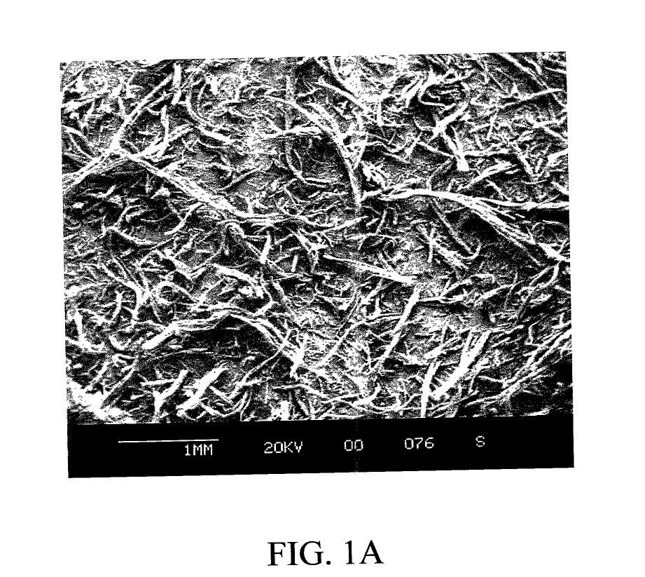

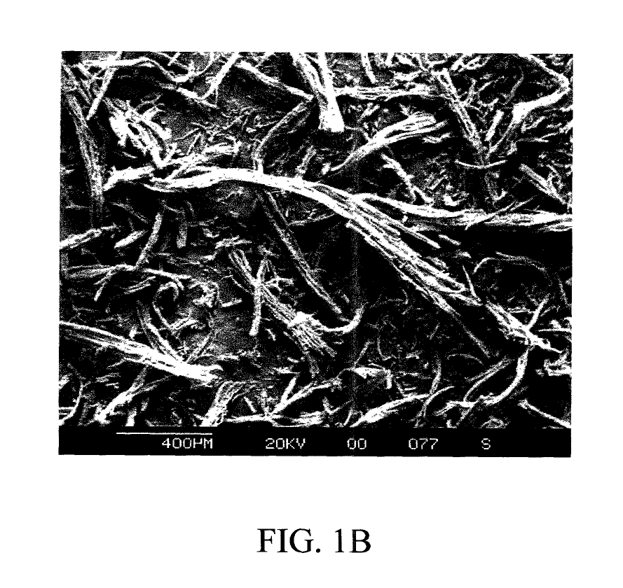

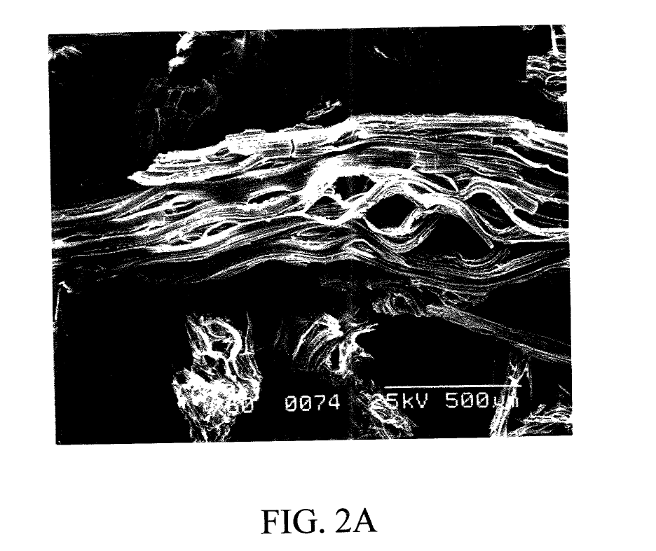

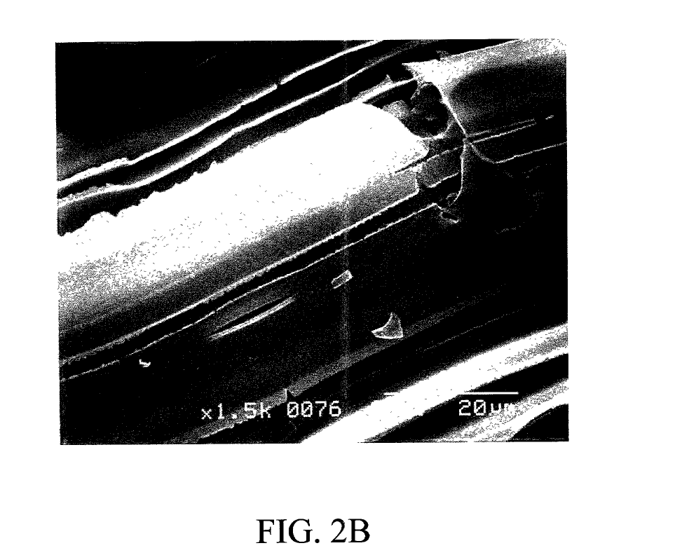

As the spinning mixture exits the spinneret, the rapid, nearly instantaneous vaporization of the flashing agent attenuates and solidifies (quenches) the carbonaceous pitch components in the spinning mixture to form pitch fibers. The evaporation of the aqueous component in the spinning mixture also applies a stretching force on the pitch, which orients the mesophase domains along their length. The energy of the vaporization process also fractures the resulting fibers to yield the short discontinuous polyfilamentary pitch formations shown in, for example, FIGS. 1-2.

The polyfilamentary pitch fibers are then preferably stabilized using conventional processes to increase the melting point of the material. Following stabilization, the fibers may be carbonized at 600 to 1700° C., preferably 1000-1500° C., and/or graphitized at greater than about 1700° C., preferably about 1700° C. to 3200° C., to form high strength carbon and/or graphite fibers.

At a given temperature, process conditions, such as, for example, the amount of flashing agent and the pressure, may be modified as necessary to control the form of the resulting pitch fiber. For example, if the flashing agent content in the spinning mixture is increased and higher pressures are applied to the spinning mixture in the region upstream of the spinneret, the typical flash spun product will be shorter polyfilamentary pitch fibers or small particles resembling a powder. If the flashing agent content in the spinning mixture is decreased and lower pressures are applied to the flashing mixture in the region upstream of the spinneret, the typical flash-spun product will consist of longer and larger polyfilamentary fibers and may form foam-like materials.

Preferably, the polyfilamentary pitch/carbon fibers have a length of about 100 μm to about 5000 μm, more preferably 100 μm to 1000 μm; a diameter of about 10 μm to about 100 μm; an aspect ratio of 5:1 to 500:1, more preferably 5:1 to 50:1. The fibers preferably have a bulk density of 0.05 to 0.5 g/cc as measured by the test procedures outlined in ASTM D-4292.

The polyfilamentary fibers have a non-linear, branched, highly irregular three-dimensional morphology. These fibers are readily distinguishable from the typically cylindrical, rod-like fibers prepared by conventional (melt-spinning or blow-spinning) processes. The flash-spun fibers include internal voids and have a much more irregular surface than the generally smooth surfaces of the carbon fibers produced from conventional processes. When the polyfilamentary fibers are flash spun from a liquid crystalline mesophase pitch, the mesophase domains are highly elongated substantially along the longitudinal axes of the fibers.

These features, i.e., branched or irregular morphological forms, as well as uneven surfaces, are important in increasing the compatibility of the flash spun polyfilamentary fibers with other materials, in particular polymeric resins within which they may be embedded. For example, when the polyfilamentary fibers provided by the present invention are incorporated into a resin material, such as a thermoplastic polymer, or a curable resin such as an epoxy resin, their complex morphology and open texture provides excellent physical coupling of the resin and fiber. The generally irregular morphology of the polyfilamentary fibers also improves compatibility with the polymer matrix, thus diminishing or eliminating the need for any fiber surface treatment.

By way of non-limiting examples, the polyfilamentary fibers may be combined with and incorporated into one or more materials including, thermoplastics, thermosets, rubbers and mixtures thereof. The polyfilamentary fibers may be included in any amount that may improve the electrical or thermal conductive properties, or the strength, of the polymeric resins. Typically the polyfilamentary carbon fibers may be included in the resin in such minor amounts such as from about 5% by weight to up to about 60% by weight, although loading levels from about 5% by weight to about 40% by weight are preferred to maintain the other physical properties of the resin material.

The polyfilamentary fibers may be blended with other carbonaceous materials and incorporated into a resin matrix, such as, for example, conventional carbon fibers melt or blow spun from pitches, and fibers produced from polyacrylonitrile based carbon fibers. Any of these fibers may be comminuted, milled, or chopped to a suitable size. Still further non-limiting examples of carbonaceous materials that may be blended with the polyfilamentary fibers include coke, and comminuted graphite, which may be either synthetic or naturally occurring. The carbonaceous material may be, but need not be graphitic in nature.

The polyfilamentary carbon and graphite fibers derived from the pitch fibers described herein may be incorporated into a resin by conventional methods that are known and practiced in the art, such as with an extruder or other device. Alternately, measured amounts of the polyfilamentary fibers can be pre-blended with a resin in a comminuted form, i.e., pellets, prills or powders, to form a preblend, and thereafter this preblend can be fluidized such as by melting the polymer.

The three dimensional structure of the polyfilamentary fibers provides high fiber-to-fiber contact in a resin at low loading levels, which enhances the thermal and/or electrical conductivity of the resin matrix compared to similar loading levels of conventional carbonaceous fibers such as, for example, conventional carbon fibers produced by blow-spinning or melt-spinning processes, graphitized carbon fibers produced by these processes, as well as other forms of carbon including comminuted naturally occurring or synthetically produced carbons and graphites. The low bulk density fibers and three dimensional structure of the fiber matrix also occupies a relatively large volume, compared to conventional carbonaceous fibers, at a given loading level, which provides a relatively lightweight composite structure. The internal voids in the fibers further contribute to the lightness of the resulting composite.

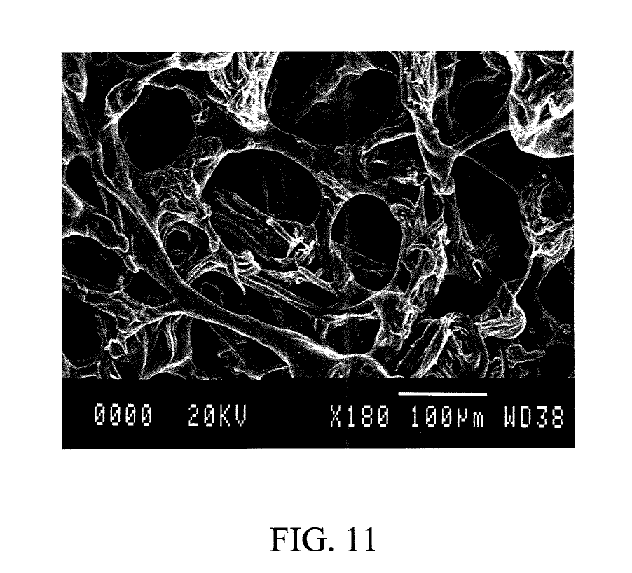

The conditions at the fiber collection receptacle may also be controlled to produce a wide range of structures employing the fibers. For example, the pitch fibers expelled from the spinneret may be collected on a heated surface with a temperature below the spinning temperature, but above room temperature. On contact with the surface, the pitch fibers melt slightly and connect with one another to form a three dimensional framework. If the heated surface is a moving belt, the belt speed may be controlled to provide a desired material thickness. After the collection surface cools, the resulting structure may be removed and subsequently carbonized or graphitized to form a high-strength porous film. The porous film typically has a thickness of about 100 μm to about 1000 μm (0.004 inch to 0.04 inch). As shown in FIG. 11, the film has an average pore size of about 150 μm, and includes interconnected struts having an average diameter of about 25 μm. The stretching stress applied to the struts as the aqueous spinning mixture evaporates during the flash spinning process provides improved mechanical properties compared to conventional porous carbon structures.

The porous film may be used in, for example, medical devices, electronic devices, energy supply facilities, catalyst support, as a filter or an absorbent, or as a shield against electromagnetic radiation. The film may also be impregnated with a polymer and made into a reinforced composite to take advantage of its enhanced mechanical strength. The continuous carbon framework also makes the polymer impregnated film highly thermally and electrically conductive.

Further specific embodiments of the invention, including the description of certain preferred embodiments are detailed in the following Examples.

### EXAMPLES

### Example 1

A solvated mesophase pitch was prepared from a refinery decant oil by heat soak and extraction as described in U.S. Pat. Nos. 5,259,947 and 5,437,780, incorporated herein by reference. The solvated mesophase pitch was 95 area percent anisotropic as determined by polarized light microscopy of a freshly broken surface. The pitch was solvated by toluene at about 20 weight percent, based on the total weight of the pitch.

A spinning mixture was formed by combining 20 g of crushed solvated mesophase pitch, 14 g water, 50 drops of toluene (approximately 2 ml to make up for evaporative losses of solvating solvent) and 0.1 g of a surfactant available from 3M Co., St. Paul, Minn. under the trade designation Fluorad FC-98. The spinning mixture comprised 40% by weight flashing agent.

The mixture was then heated to 210° C. in the twin cell flash spinning apparatus described in U.S. Pat. No. 5,023,025. After the sample melted, it was mixed in the twin cell flash-spinning unit by forcing it through an internal static mixer.

Once the temperature of the unit had equalized, a constant pressure of 8274 kPa (1200 psig) was applied, thereby forcing the material through a 0.762 mm (0.030-inch) spinneret. The resulting discrete, elongated polyfilamentary pitch fibers had a distinct orientation along their longitudinal axes. Nonetheless an irregular morphology was found and is visible. The pitch fibers were solidified and collected on a screen. The shape and structure of the fibers are illustrated in FIGS. 1A and 1B. The rate of production was 54.4 kg/hr (120 lb/hr) through the 0.762 mm (0.030-inch) orifice.

### Example 2

Twenty grams (20 g) of Mitsubishi Gas Chemical ARA 200 mesophase pitch were combined with 14 g of water and 0.1 g of Fluorad FC-98 surfactant to form a spinning mixture. The spinning mixture was loaded into a twin cell flash spinning unit as described in Example 1 and the unit was heated to 210° C. Mixing of the pitch was accomplished by forcing the material through a static mixer located within the flash spinning unit by applying a differential pressure of 2758 kPa (400 psig) between the cells.

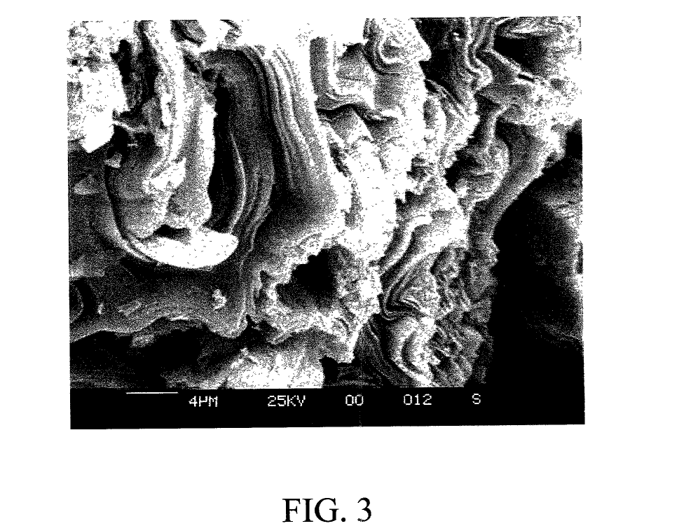

Once the temperature had equalized, a constant pressure of 5861 kPa (850 psig) was applied and the material was forced through a 0.762 mm (0.030-inch) orifice. The oriented polyfilamentary pitch fibers were collected on a screen. The polyfilamentary structure and elongated mesophase domains of the fiber product of this Example are shown in FIGS. 2A, 2B and 3.

### Comparative Example 1

A spinning mixture was formed by combining 20 g of the solvated mesophase pitch of Example 1, 50 drops of toluene and 0.1 g of Fluorad FC-98 surfactant, but no flashing agent was included in the mixture. This mixture was placed in the twin cell flash-spinning unit described in Example 1 and heated to 210° C. Forcing the mixture through an internal static mixer located within flash spinning unit mixed the pitch sample. Once the temperature of the unit was stabilized the pitch was forced through a 0.762 mm (0.030-inch) spinneret by application of 8894 kPa (1200 psig). As the pitch exited the spinning unit it resembled a “noodle”. The pitch did not cool or harden immediately. Instead, it dropped to the collection area and solidified in a non-directional, free form mass.

### Example 3

A solvated mesophase pitch was prepared from a refinery decant oil by the steps of heat soak and supercritical solvent extraction as described in U.S. Pat. No. 5,032,250, incorporated herein by reference. The solvated mesophase pitch contained 85% by weight of pitch, and 15% by weight of a solvent mixture including phenanthrene and a solvent obtained as a by-product of pitch production that contained 1-4 membered ring aromatic compounds having a molecular weight of about 150-400. A spinning mixture was formed by combining 20 g of the mesophase pitch, 6 g of water as a flashing agent, 0.3 g of PVA (polyvinyl alcohol) as a dispersing agent and 3 g of toluene as plasticizer. The spinning mixture was loaded into a twin cell flash spinning unit as described in Example 1, heated to 230° C., and mixed by forcing the fluid through a static mixer within the unit using differential pressure between the cells. Once the temperature of the unit equalized, a pressure of 5378 kPa (780 psig) was applied to force the material through a 0.762 mm (0.030-inch) orifice. A mat of fine polyfilamentary pitch fibers was produced.

### Example 4

Two spinning mixtures were prepared and spun into fibers as described below. Spinning was performed in the twin cell-spinning unit described in Example 1, by the method described in Example 3. The results are shown in Table 1 below.

TABLE 1

| | | | | Spinning Temp., | |
|---|---|---|---|---|---|
| Ex. | ARA 200 | Water | FC-98 | ° C. | Pres., kPa (psig) |
| 4A | 25 g | 6 g | 0.5 g | 259 | 6619 (960) |
| 4B | 25 g | 6 g | None | 250 | 7067 (1025) |

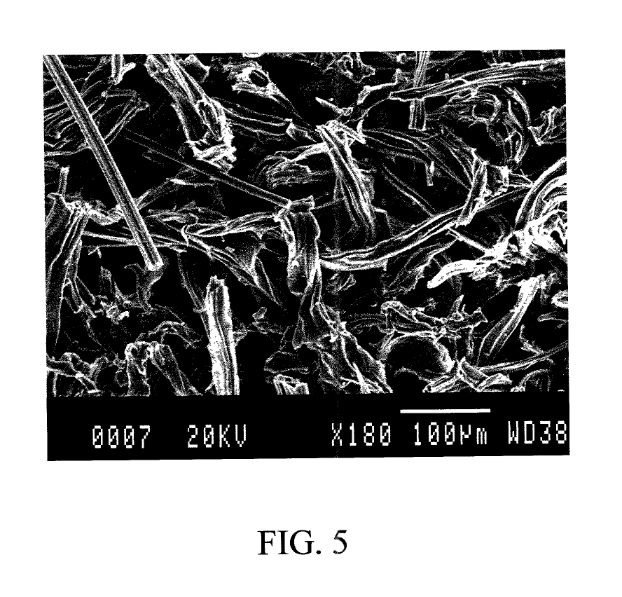

Both spins made good polyfilamentary fiber although the spin without surfactant made somewhat shorter and wider fibers. The fibers are shown in FIG. 5.

### Example 5 and Comparative Example 2

Five spinning mixtures were prepared and spun into fibers as described below. Spinning was performed in the twin cell-spinning unit described in Example 1, by the method described in Example 3. The results are shown in Table 2 below.

TABLE 2

| | Pitch | | | Temp., | |
|---|---|---|---|---|---|
| Ex. | ARA 200 | Water | Toluene | ° C. | Pres., kPa (psig) |
| C2 | 25 g | none | 1.0 g | 265 | 4792 (695) |
| 5A | 25 g | 0.5 g | 1.0 g | 265 | 4723 (685) |
| 5B | 25 g | 0.8 g | 1.0 g | 255 | 4826 (700) |
| 5C | 25 g | 1.0 g | 1.0 g | 265 | 4826 (700) |
| 5D | 25 g | 2.0 g | 1.0 g | 260 | 6233 (904) |
| 5E | 25 g | 3.0 g | 1.0 g | 265 | 4826 (700) |

A comparative mixture C2, run with no flashing agent, did not produce fibers. Runs 5A and 5B made fibers but there was insufficient energy to make good polyfilaments. Runs 5C, 5D and 5E produced a high yield of polyfilamentary carbon fibers.

### Example 6

A spinning mixture was formed by combining 25 g of Mitsubishi Gas Chemical ARA 220 mesophase pitch, 2.5 g of water as a flashing agent and 3.7 g of phenanthrene as a plasticizer. The spinning mixture was loaded into a twin cell flash-spinning unit described in Example 1 and heated to 255° C. The mixture was mixed by forcing the fluid through a static mixer within the unit using differential pressure between the cells. Once the temperature of the unit equalized, a pressure of 6433 kPa (933 psig) was applied to force the material through a 0.762 mm (0.030-inch) orifice. A dense polyfilamentary pitch fiber was produced. Bulk density was measured at 0.155 g/cc. Vibrated bulk density was evaluated to be 0.23 g/cc. The surface texture of the fibers appeared somewhat wet under the microscope.

### Example 7 and Comparative Example 3

A solvated mesophase pitch was prepared by liquid/liquid extracting Mitsubishi Gas Chemical ARA 240 mesophase pitch with four parts by weight of tetralin at 300° C. at about 827 kPa (120 psig) pressure. Dry insolubles obtained in 64% yield were solvated in a 7:2 ratio with phenanthrene to form a phenanthrene solvated mesophase pitch. The dry insolubles softened at 355° C. and melted at 397° C. The phenanthrene solvated mesophase pitch was fluid at 206° C.

Spinning mixtures were prepared using the phenanthrene solvated mesophase pitch and water and these mixtures were spun into fibers as described below. Spinning was performed in the twin cell spinning unit described in Example 1 by the method described in Example 3. The results are shown in Table 3 below.

TABLE 3

| Ex. | Pitch | Water | Temp., ° C. | Pres., kPa (psig) |
|---|---|---|---|---|
| C3 | 30 g | none | 232 | 3509 (509) |
| 7A | 30 g | 0.5 g | 230 | 5026 (729) |
| 7B | 25 g | 1.0 g | 230 | 4875 (707) |
| 7C | 25 g | 2.0 g | 246 | 4723 (685) |

A comparative mixture, C3, with no flashing agent did not produce fibers at the flashing temperature of 232° C. Runs 7A, 7B and 7C made excellent long polyfilamentary pitch fibers at similar flashing temperatures. The fibers had a somewhat glassy surface appearance, and very high aspect ratio (at least 500:1) thread-like fibers were observed in the Run 7C product. The polyfilamentary fibers from Run 7C were highly charged with static electricity while fibers from the higher water content runs formed a nice mat. This effect demonstrated that water also acts as an anti-static agent when incorporated into the spinning mixture.

### Example 8

A spinning mixture was prepared by combining 30 g of phenanthrene solvated mesophase pitch as described in Example 7 with 2 g of water. The mixture was loaded into the twin cell spinning unit described in Example 1 and melted at 245° C. The spinning mixture was mixed by forcing it through an internal static mixer; the mixture was then pressurized to 4826 kPa (700 psig) and discharged over 4.6 seconds through a 0.762 mm (0.030-inch) orifice to produce fluffy polyfilamentary pitch fibers. Spinning rate was 23.6 kg (52 pounds) per hour. Bulk density of the fiber mat was 0.83 g/cc and the vibrated bulk density was 0.114 g/cc. Typical filaments from this run were about 2 mm in length and were composed of pieces averaging 25 microns in diameter; however, some pieces were 6 to 7 mm long. Diameter varied widely due to the complex structure of the fibers.

Six batches of fiber were prepared to make polyfilamentary fiber for testing in composites. The pitch fibers were oxidatively stabilized in an open dish in the presence of air. The fibers were heated from room temperature (approx. 20° C.) to 200° C. at 5° C. per minute, there held for 10 hours, then heated to 240° C. at 5° C. per minute, held at 240° C. for 9 hours, then heated to 270° C. at 5° C. per minute and finally held at 270° C. for 5 hours. The oxidized polyfilamentary fibers were graphitized by heating in an inert atmosphere from 270° C. to 2500° C. at 25° C. per minute and holding at 2500° C. for 20 minutes.

### Example 9

The graphitized polyfilamentary carbon fibers of Example 8 were comminuted by vigorously stirring in an aqueous slurry and then dried. The dried fibers had a helium density of 2.18 indicating minimal closed porosity. Bulk density was 0.101 g/cc, vibrated bulk density was 0.147 g/cc. Shape analysis on the fibers is summarized in Table 4 below:

TABLE 4

| | Length, mm | Diameter, mm | Aspect Ratio |
|---|---|---|---|
| Mean | 0.386 | 0.025 | 19.0 |
| Minimum | 0.13 | 0.004 | 4.8 |
| Maximum | 0.82 | 0.051 | 64 |
| Standard | 0.17 | 0.013 | 11.2 |
| Deviation | | | |

Composite plates were made by manually mixing the graphitized polyfilamentary carbon fibers with a resin available from Shell Oil Co. under the trade designation EPON 828/TETA epoxy. The graphitized polyfilamentary carbon fibers comprised 40% wt. of the composite plates, with the balance to 100% wt. of the EPON 828/TETA epoxy. The mixture was poured in a 12.7 cm by 17.8 cm (5 inch by 7 inch) mold and cured at room temperature overnight in a press under a 20,000 psi load. The cured plate was precision machined to make a 12.7 cm by 17.8 cm by 0.95 cm (5 inch by 7 inch by 3/8 inch) thick test piece.

Three test pieces were measured for through thickness thermal conductivity at 50° C. The pieces averaged 4.4 W/m°K. Density of the composites averaged 1.352 g/cc. For comparison, Epon 828/TETA tests 0.25 W/m°K through plate thermal conductivity.

Another comparative test plate was made from 20 weight percent milled synthetic, 3000° C. heat treated graphite and 20 weight percent, 2500° C. heat treated pitch carbon fibers in Epon 828/TETA. This plate tested 2.25 W/m°K through plate thermal conductivity.

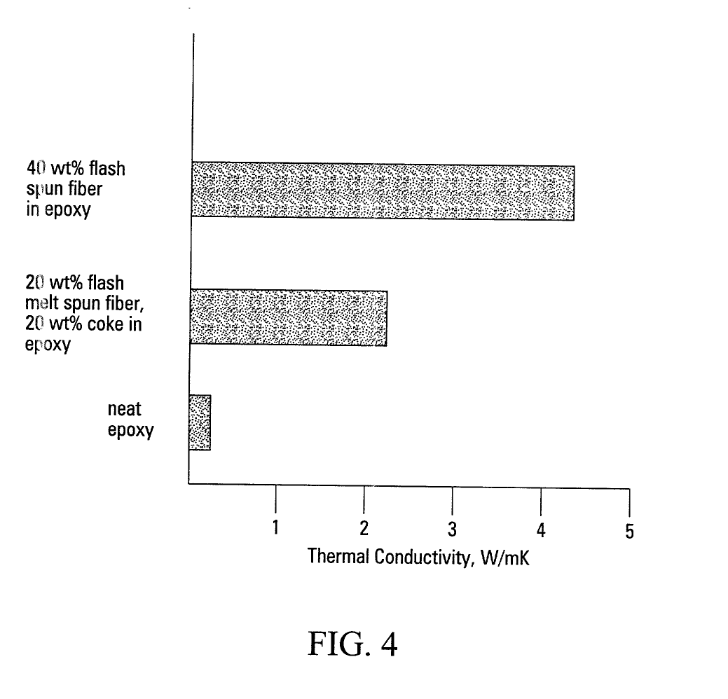

As shown in FIG. 4, the graphitized fibers improved the thermal conductivity of the resulting composite by at least 1700% versus the epoxy without any fibers (4.4 W/mK versus 0.25 W/mK). Further, the thermal conductivity of the composite comprising 40% by weight percent flash spun fiber was nearly double that of a composite comprising 20 weight percent synthetic graphite and 20 weight percent conventional melt spun mesophase pitch carbon fiber.

### Example 10

A carbonaceous pitch with a melting point of about 390° C. to about 450° C. was combined with a solvent mixture to make a solvated mesophase pitch as described in U.S. Pat. No. 5,032,050. The solvent mixture included phenanthrene as a primary component and minor amounts of a solvent mixture obtained as a by-product of pitch production that contained 1-4 membered ring aromatic compounds having a molecular weight of about 150-400. The solvated pitch was combined with xylene as a plasticizer and with water as a flashing agent. Varying amounts of a rosin available from Westvaco Corp. under the trade designation Rosin S were added as a dispersing agent to form the spinning mixtures set out in Table 5 below.

The spinning mixtures were spun into fibers using the apparatus shown in FIG. 10. The spin temperature was 275° C., the pressure was 1000 psig, and the nozzle diameter was 0.020 inches.

TABLE 5

| Example: | 10A | 10B | 10C | 10D |
|---|---|---|---|---|
| Solvated mesophase pitch (g) | 380 | 380 | 380 | 380 |
| (wt. % of spinning mixture) | (75) | (74) | (73) | (72) |
| Xylene (g) | 67 | 67 | 67 | 67 |
| (wt. % of spinning mixture) | (13) | (13) | (13) | (13) |
| Water (g) | 55.8 | 55.8 | 55.8 | 55.8 |
| (wt. % of spinning mixture) | (11) | (11) | (11) | (11) |
| Rosin (g) | 5.25 | 10.5 | 15.75 | 21.0 |
| (wt. % of spinning mixture) | (1) | (2) | (3) | (4) |
| Spin rate, lbs./hr. | 50.8 | 62.6 | 80.9 | 96.7 |
| Polyfilamentary carbon fiber | 333 | 363 | 347 | 366 |
| produced (g) | | | | |
| % polyfilamentary carbon | 56.2 | 58.7 | 59.9 | 75.4 |
| fibers passing through Tyler | | | | |
| 325 mesh | | | | |

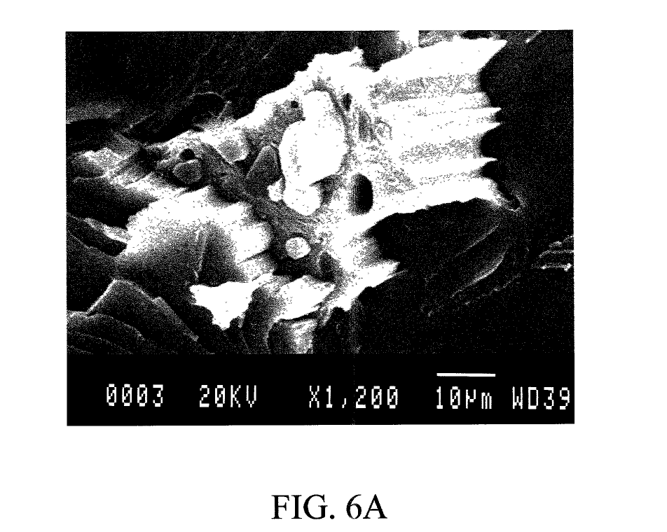

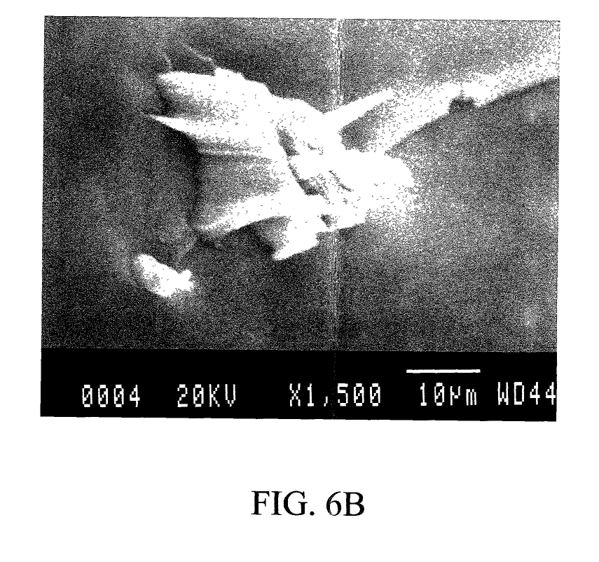

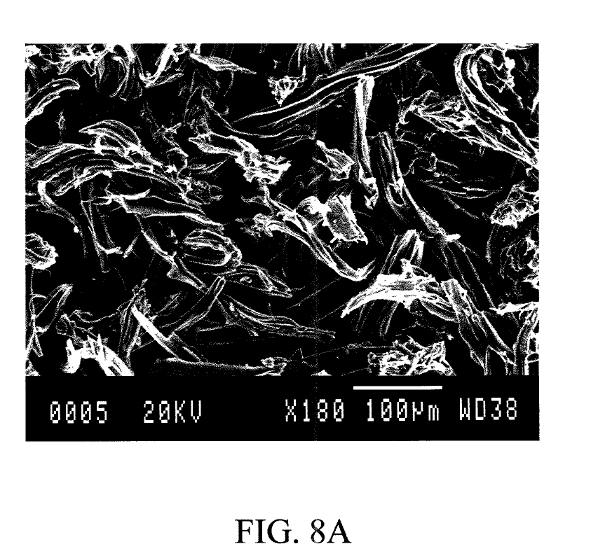

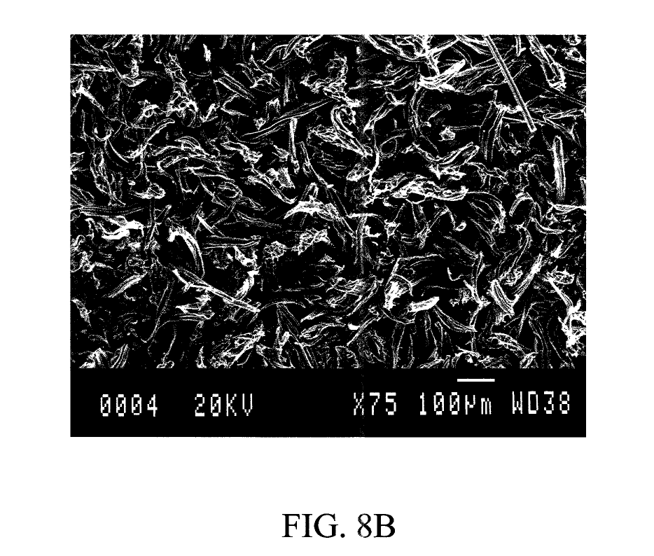

As the data from this table shows, the spin rate improved with increasing amounts of rosin, and also the percentage of the polyfilamentary carbon fibers produced having a sufficiently small particle size to pass through a Tyler 325 mesh (average particle size <42 microns) also increased. From the foregoing it is seen that the use of rosins, in increased amounts, increases spin rate as well as permits for the production of increased amounts of smaller polyfilamentary fibers. The fibers are shown in FIGS. 8A and 8B, and FIGS. 6A and 6B show the fibers embedded in an epoxy resin.

### Example 11

For each of these examples, the solvated mesophase pitch of Example 10 was first extracted using xylene so to reduce the solvent level to no more than 2% by weight and form a dry mesophase pitch. The dry mesophase pitch was mixed with phenanthrene in the amounts indicated on the following Table 6 and combined with water to form a spin mixture. To one spin mixture were added the rosin used in Ex. 10, while no rosin was added to the other spin mixture. These mixtures were spun into fibers using the pressurized vessel described in Example 10 and by the method described therein. The spin nozzle diameter was 0.020 inch for all of the examples. For spinning mixtures 11A and 11B, the temperature was 300° C., and the pressure was 1200 psig. The results are shown in Table 6 below.

TABLE 6

| Example: | 11A | 11B |
|---|---|---|
| Dry mesophase pitch (g) | 300 | 300 |
| (wt. % of spinning mixture) | (69) | (66) |
| Phenanthrene (g) | 26 | 26 |
| (wt. % of spinning mixture) | (6) | (6) |
| Water (g) | 109 | 109 |
| (wt. % of spinning mixture) | (25) | (24) |
| Rosin (g) | 0 | 18.1 |
| (wt. % of spinning mixture) | (0) | (4) |
| Spin rate, lbs./hr. | — | 6 |
| Polyfilamentary carbon fiber | — | 238 |
| produced (g) | | |
| Bulk density, g/cc | — | 0.22 |

As the data from this table shows relating to Ex. 11A, the spinning temperature of 300° C. was too low to produce a fiber in the absence of the rosin. However the results relating to Example 11B indicated good production of polyfilamentary fibers of a low bulk density, which is an indicia of a particularly “curly” polyfilamentary fibers. These examples illustrate the plasticizing function of the rosin in this spinning mixture and under these spinning conditions.

### Example 12

For each of the following examples, 61.6 g samples of the xylene extracted dry pitch as described in Example 11 was mixed with 23.4 g of the mixture of solvents described in Ex. 10 to form a solvated pitch containing 28% by weight of solvent. The solvated pitch was then combined with 10.3 g water to form a spin mixture.

To one spin mixture was added 1.0 g of tall oil commercially obtained under the trade designation M-28B from Westvaco Corp., while no tall oil was added to a second spin mixture. These mixtures were spun into fibers using the pressurized vessel described in Example 10 and by the method described therein. The spin temperature was 292° C., the pressure was 1050 psig, and the nozzle diameter was 0.030 inches. The results are shown in Table 7 below.

TABLE 7

| Example: | 12A | 12B |
|---|---|---|
| Dry Mesophase pitch (g) | 61.6 | 61.6 |
| Solvent (g) | 23.4 | 23.4 |
| Water (g) | 10.3 | 10.3 |
| Tall oil (g) | 0 | 1.0 |
| % tall oil of spin mixture | 0 | 1 |
| % polyfilamentary carbon | 30.5 | 40.0 |
| fibers passing through Tyler | | |
| 325 mesh | | |
| Bulk density, g/cc | 0.53 | 0.42 |

As the data from this table shows, the percentage of the polyfilamentary fibers produced having a sufficiently small particle size to pass through a Tyler 325 mesh (average particle size <42 microns) increased by using tall oil as a dispersing agent. The decreased bulk density also indicated the “curly” nature of the polyfilamentary fibers.

### Example 13

The solvated mesophase pitch of Example 10 was combined with xylene as a plasticizer and water as a flashing agent and varying amounts of Rosin S (ex. Westvaco) as the dispersing agent to form spin mixtures. The specific amounts of each of these materials is set out in Table 8 below.

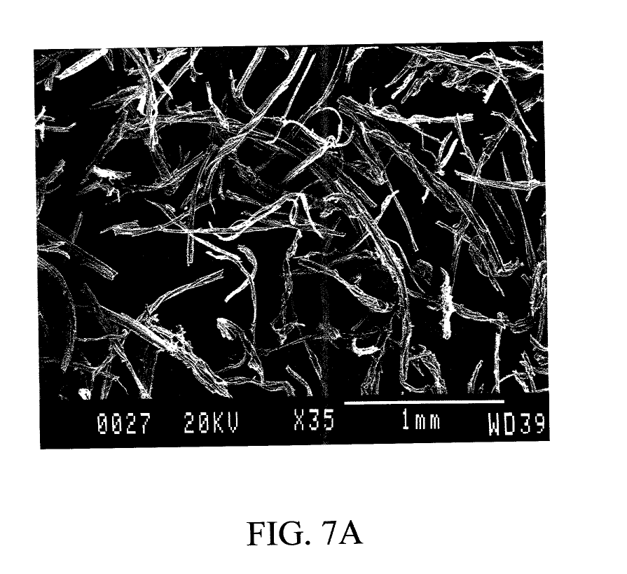

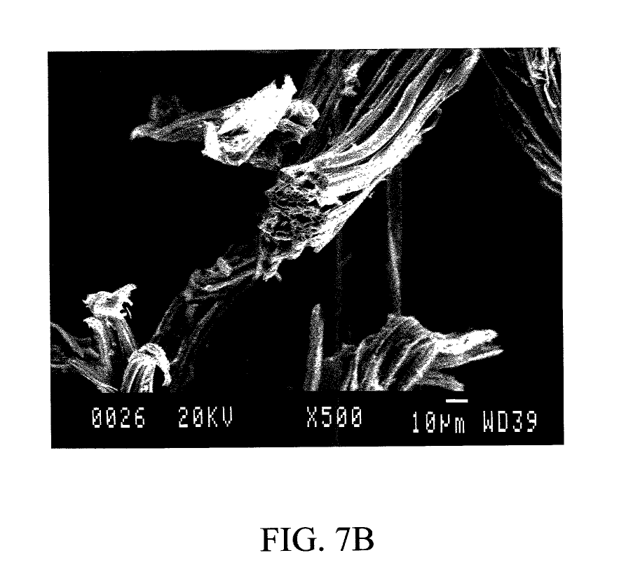

These mixtures were spun into fibers using the pressurized vessel described in Example 10 and by the method described therein. The spin nozzle diameter was 0.020 inch for all of the examples. For spinning mixture 13A the temperature was 275° C., and the pressure was 1000 psig, while for the spinning mixture of example 13B, the temperature was 280° C. and the pressure was 1000 psig. The fibers are shown in FIGS. 7A and 7B.

TABLE 8

| Example: | 13A | 13B |
|---|---|---|
| Solvated mesophase pitch (g) | 380 | 420 |
| (wt. % of spinning mixture) | (70) | (69) |
| Xylene (g) | 67 | 46 |
| (wt. % of spinning mixture) | (12) | (8) |
| Water (g) | 79 | 117 |
| (wt. % of spinning mixture) | (14) | (19) |
| Rosin (g) | 16.3 | 24 |
| (wt. % of spinning mixture) | (4) | (4) |
| Spin rate, lbs./hr. | 44.6 | 43.0 |
| Polyfilamentary carbon fiber | 326 | 335 |
| produced (g) | | |
| Bulk density, g/cc | 0.11-0.19 | 0.039-0.14 |

### Example 14

A non-solvated mesophase pitch was obtained by extracting a solvated mesophase pitch prepared from a refinery decant oil by the steps of heat soak and supercritical solvent extraction as described in Example 11 with xylene to reduce the solvent content in the mesophase pitch to no more than 2%. The dry mesophase pitch was combined with tetralin as a plasticizer and water as a flashing agent and varying amounts of Rosin S (ex. Westvaco) as the dispersing agent to form spin mixtures.

These mixtures were spun into fibers using the pressurized vessel described in Example 10 and by the method described therein. The spin nozzle diameter was 0.020 inch for all of the examples, and the spinning temperatures were 285° C. The pressure was 1000 psig for example 14A while the pressure was 1150 psig for example 14B. The results are shown in Table 9 below.

TABLE 9

| Example: | 14A | 14B |
|---|---|---|
| Dry mesophase pitch (g) | 380 | 280 |
| (wt. % of spinning mixture) | (64) | (64) |
| Tetralin (g) | 107 | 61.5 |
| (wt. % of spinning mixture) | (18) | (14) |
| Water (g) | 86 | 85 |
| (wt. % of spinning mixture) | (15) | (19) |
| Rosin (g) | 17.7 | 13.2 |
| (wt. % of spinning mixture) | (3) | (3) |
| Spin rate, lbs./hr. | 65 | 16.2 |
| Polyfilamentary carbon fiber | 376 | 253 |
| produced (g) | | |
| Bulk density, g/cc | 0.055-0.20 | 0.11-0.18 |

### Example 15

A non-solvated mesophase pitch was obtained by extracting a solvated mesophase pitch prepared from a refinery decant oil by the steps of heat soak and supercritical solvent extraction as described in Example 11 with xylene to reduce the solvent content in the mesophase pitch to no more than 2%. The dry mesophase pitch was combined with a 50:50 blend of two plasticizers, xylene and the mixture of solvents comprised primarily of phenanthrene as described in Example 13. To this composition was added water as a flashing agent and varying amounts of Rosin S (ex. Westvaco) as the dispersing agent to form a spin mixture. The specific amounts of each of these materials is set out in Table 10 below.

These mixtures were spun into fibers using the pressurized vessel described in Example 10 and by the method described therein. The spin nozzle diameter was 0.020 inch, the spinning temperature for 15A was 275° C. and for 15B was 295° C., and the pressure was 1000 psig.

TABLE 10

| Example: | 15A | 15B |
|---|---|---|
| Dry mesophase pitch (g) | 260 | 260 |
| (wt. % of spinning mixture) | (63) | (63) |
| xylene (g) | 47.3 | 47.3 |
| (wt. % of spinning mixture) | (12) | (12) |
| Solvent mixture (g) | 47.3 | 47.3 |
| (wt. % of spinning mixture) | (12) | (12) |
| Water (g) | 44 | 44 |
| (wt. % of spinning mixture) | (11) | (11) |
| Rosin (g) | 12.3 | 12.3 |
| (wt. % of spinning mixture) | (2) | (2) |
| Spin rate, lbs./hr. | 48.4 | 82.1 |
| Polyfilamentary carbon fiber | 195 | 249 |
| produced (g) | | |
| Bulk density, g/cc | 0.44 | 0.13 |

### Example 16

Two pounds of a commercially available Nylon 66 composition available from E. I. DuPont de Nemours, Inc., Wilmington, Del., under the trade designation Zytel 101, having a melting point of 263° C., was introduced into a conventional Braebender single screw extruder. The working zones of the 4-zone Braebender extruder, respectively from the inlet and to the outlet end of the apparatus, were set at operating temperatures of: 470° F., 500° F., 500° F., and 500° F. The screw was operated at 120 rpm, and had a length to diameter ratio of 1:24.

A mixture of the polyfilamentary pitch fibers produced according to Examples 11-15 was stabilized by: (1) heating the pitch fibers in air from room temperature to 260° C. at a rate of 3° C. per minute; (2) holding the fibers at 260° C. for 30 minutes; and (3) naturally cooling the fibers to room temperature. The total stabilization time was about 0.8 hours. The stabilized fibers were then graphitized at 2500° C. for 30 minutes.

To the inlet of the apparatus was provided the pelletized Nylon 66 composition blended with a 10% by weight loading of the graphitized polyfilamentary fibers. The extrudate was formed into strands which were quenched in a water bath just after their exit from the extruder, and subsequently the cooled and quenched strands were pelletized using conventional apparatus.

These resulting pellets were approximately 91% wt. Nylon 66, and 9% wt. of the poeyfilamentary pitch fibers.

Samples of these pellets were then provided to a 5×7 in. mold that had a thickness of approximately ¼ inch. The pellets were fluidized by heating them in a heated press, after which a pressure of 12 tons was applied to the mold. The mold was then removed, cooled, and the resulting molded plaque was removed from the mold. The cooled plaque was then subsequently machined into a 2 in. diameter disk having a thickness of approximately ¼ in. The disk was then tested in accordance with ASTM-F-433-98 in order to determine the thermal conductivity of the nylon/polyfilamentary carbon blend. The results indicated that the thermal conductivity of the sample was 0.58 W/mK, which is approximately more than twice the thermal conductivity of the pure Nylon 66. The density of the two-inch diameter disk was also determined to be 1.09 g/cc.

### Example 17

In the following examples, composite plaques were made by manually mixing one or more of the carbon materials indicated on the table below with Epon 828/TETA epoxy. The form and amount of the carbon materials included in each one of the sample composite plaques are shown in Table 11 below. The remaining balance of each composition, to 100% by wt. was Epon 828/TETA epoxy.

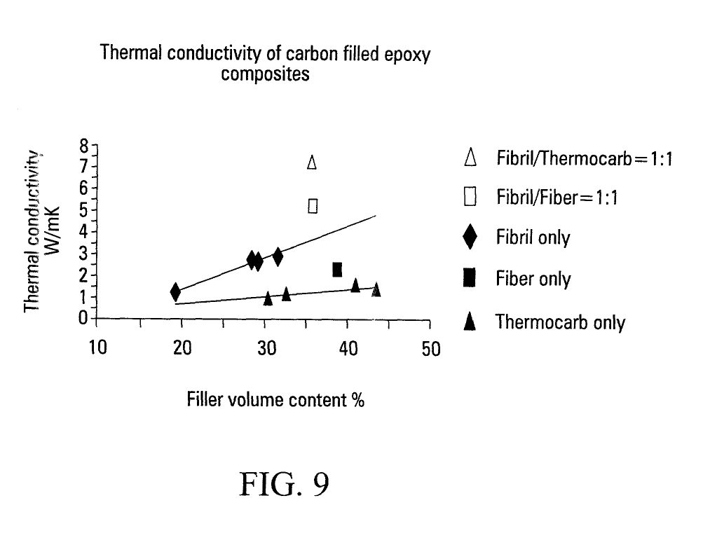

Each of the compositions was first made by pre-blending the carbon materials (if two or more carbon materials were included) to form a dry premixture. Then the hardener and epoxy were mixed in respective ratio of 1:2 parts, and subsequently the carbon materials was manually added and mixed to insure a good dispersion within the Epon 828/TETA epoxy. Thereafter, each mixture was poured into a 5 in.×7 in. mold, approximately ¼ inch thick, and allowed to cure at room temperature overnight in a press under a 12-ton load. Subsequently, each cured plaque was removed from the mold. Each plaque was then machined to produce a two-inch diameter disk, each disk having a thickness of approximately ¼ inches. Each disk was tested in accordance with the ASTM-F-433-98 in order to determine thermal conductivity of each one of the samples. The results of this evaluation are depicted in FIG. 9.

With regard to the nature of the carbon materials which were included in one or more of the samples, the polyfilamentary carbon was a blend of the polyfilamentary carbon fibers produced according to Examples 11-15. These are referred to as “Fibrils” in FIG. 9. The fibers referred to in FIG. 9 and Table 11 below were conventional chopped and graphitized mesophase pitch carbon fibers which had an average length of about 1 mm, and a diameter of about 10 microns. These carbon fibers were spun from solvated pitches of the type described in one or more of U.S. Pat. Nos. 5,259,947; 5,437,780; 5,540,832 or 5,501,788. These fibers are spun using conventional spinning techniques into linear fibers, which were subsequently stabilized, carbonized and graphitized prior to their inclusion in the compositions according to this example. The material available under the trade designation Thermocarb from Conoco, Inc., Houston, Tex., was a high purity, finely ground synthetic graphite with an average particle size of about 125-150 microns.

TABLE 11

| | | Spun and Chopped | Comminuted |
|---|---|---|---|
| | Polyfilamentary | Mesophase pitch | synthetic graphite |
| | carbon fibers | carbon fibers, | (“Thermocarb”) |
| Example | (“Fibrils”), % wt. | % wt. | % wt. |
| 17A | — | — | 30 |
| 17B | — | — | 33 |
| 17C | — | — | 41 |
| 17D | — | — | 44 |
| 17E | — | 38 | — |
| 17F | 18 | — | — |
| 17G | 28 | — | — |
| 17H | 29 | — | — |
| 17I | 32 | — | — |
| 17J | 18 | 18 | — |
| 17K | 18 | — | 18 |

As can be seen from the results depicted on FIG. 9, the blends of polyfilamentary carbons fibers (Fibril) with either the synthetic graphite (Thermocarb), or the polyfilamentary carbon fibers (Fibril) with graphitized chopped mesophase pitch carbon fibers provided a synergistic improvement in the observed thermal conductivity tested according to ASTM-F-433-98.

### Example 18

A spinning mixture was prepared that included 61.6 g dry mesophase pitch, 23.4 g phenanthrene, 10.3 g water, and 0.95 g tall oil. The spinning mixture was flash spun at a spinning temperature of 245° C. and a pressure of 570 psig. The resulting pitch fibers were collected on a heated substrate maintained at a temperature of 150-200° C. to form a porous film.

### Example 19

A spinning mixture was prepared that included 300 g solvated mesophase pitch (with 15% by weight of the mixture of solvents described in Example 10), 53.0 g water, and 14.7 g rosin. The spinning mixture was flash spun at a spinning temperature of 300° C. and a pressure of 1200 psig. The resulting pitch fibers were collected on a heated substrate maintained at a temperature of 200-250° C. to form a porous film.

Other embodiments of the present invention will be apparent to those skilled in the art from a consideration of this specification or practice of the invention disclosed herein. It is intended that the specification be considered as only exemplary, with the true scope and spirit of the invention being indicated by the following claims.

What is claimed is:

1. A non-linear polyfilamentary pitch fiber with a diameter of 10-100 μm, a length of 100-5000 μm, and an aspect ratio of 5:1 to 500:1.

2. The fiber of claim 1, wherein the fiber has a bulk density of 0.05 to 0.5 g/cc.

3. The fiber of claim 1, wherein the fiber comprises internal voids.

4. The fiber of claim 1, wherein the fiber has oriented, continuous graphitic domains.

5. A non-linear polyfilamentary carbon or graphite fiber with a diameter of 10-100 μm, a length of 100-5000 μm, and an aspect ratio of 5:1 to 500:1.

6. The fiber of claim 5, wherein the fiber has a bulk density of 0.05 to 0.5 g/cc.

7. The fiber of claim 5, wherein the fiber comprises internal voids.

8. The fiber of claim 5, wherein the fiber has oriented, continuous graphitic domains.

9. The fiber of claim 5, wherein the fiber has a length of 100-1000 μm and an aspect ratio of 5:1 to 50:1.

10. A resin comprising the fiber of claim 5.

11. The resin of claim 10, wherein the resin is loaded with from about 5% by weight to about 60% by weight of the fiber.

12. The resin of claim 11, wherein the resin is an epoxy resin.

13. The resin of claim 10, further comprising a second material selected from coke, graphite and conventional carbon fibers.

14. A film comprising the fiber of claim 5.

15. A process for making fibers, comprising: (a) providing a spinning mixture comprising a dispersion of: (i) an excess of a carbonaceous pitch, and (ii) a flashing agent; (b) passing the spinning mixture from a high pressure region through an orifice to a low pressure region to form pitch fibers.

16. The process of claim 15, further comprising further treating the pitch fiber to form one of a carbon fiber and a graphite fiber.

17 The process of claim 15, wherein the spinning mixture comprises water.

18. The process of claim 15, wherein the flashing agent is water.

19. The process of claim 15, wherein the pitch is a mesophase pitch.

20 The process of claim 15, wherein the spinning mixture further comprises a dispersing agent.

21 The process of claim 20, wherein the dispersing agent is selected from the group consisting of rosin, tall oil and mixtures thereof.

22. The process of claim 15, wherein the spinning mixture further comprises a plasticizer.

23 The process of claim 22, wherein the plasticizer is an aromatic solvent.

24. The process of claim 20, wherein the spinning mixture further comprises a plasticizer.

25 The process of claim 24, wherein the plasticizer is an aromatic solvent.

26. The process of claim 23, wherein the solvent comprises a compound selected from the group consisting of toluene, xylene, phenanthrene, tetralin, and solvent mixtures comprising aromatic compounds with 1-4 rings, wherein the aromatic compounds have a molecular weight of about 150-400; and mixtures thereof.

27. The process of claim 25, wherein the solvent comprises a compound selected from the group consisting of toluene, xylene, phenanthrene, tetralin, and solvent mixtures comprising aromatic compounds with 1-4 rings, wherein the aromatic compounds have a molecular weight of about 150-400; and mixtures thereof.

28 The process of claim 15, wherein the spinning mixture comprises about 55% to about 99% by weight of the carbonaceous pitch and about 1% to about 45% by weight of the flashing agent, with a total of 100% by weight.

29 The process of claim 28, wherein the spinning mixture comprises water.

30 The process of claim 28, wherein the flashing agent is water.

31. The process of claim 28, wherein the spinning mixture further comprises up to about 8% by weight of a dispersing agent.

32 The process of claim 28, wherein the spinning mixture further comprises up to about 4% by weight of a dispersing agent.

33 The process of claim 31, wherein the dispersing agent is a compound selected from the group consisting of rosins, tall oils and mixtures thereof.

34. The process of claim 32, wherein the dispersing agent is a compound selected from the group consisting of rosins, tall oils and mixtures thereof.

35. The process of claim 28, wherein the spinning mixture further comprises up to about 20% by weight of a plasticizer.

36. The process of claim 35, wherein the plasticizer is an aromatic solvent.

37. The process of claim 36, wherein the aromatic solvent is selected from the group consisting of toluene, xylene, phenanthrene, tetralin, and solvent mixtures comprising aromatic compounds with 1-4 rings, wherein the aromatic compounds have a molecular weight of about 150-400; and mixtures thereof.

38. The process of claim 15, wherein the spinning mixture is heated to a temperature of at least 50° C. greater than the atmospheric boiling point of the flashing agent.

39. The process of claim 15, wherein the pressure in the high pressure region is 500-1500 psig.

40. A process for making a polymeric resin, comprising (a) providing a spinning mixture comprising about 55% to about 99% by weight of a carbonaceous pitch, and about 1% to about 45% by weight of a flashing agent, (b) heating and pressurizing the spinning mixture in a high pressure region; (c) passing the spinning mixture from the high pressure region through a spinneret to a low pressure region to form pitch fibers; (d) treating the pitch fiber to form one of a carbon fiber and a graphite fiber; and (e) incorporating the carbon and/or graphite fibers into a polymeric resin.

41. The process of claim 40, wherein the spinning mixture further comprises up to about 4% by weight of a dispersing agent.

42 The process of claim 41, wherein the dispersing agent is a compound selected from the group consisting of rosin, tall oil and mixtures thereof.

43 The process of claim 40, wherein the spinning mixture further comprises up to about 20% by weight of a plasticizer.

44. The process of claim 43, wherein the plasticizer is an aromatic solvent.

45 The process of claim 44, wherein the aromatic solvent is selected from the group consisting of toluene, xylene, phenanthrene, tetralin, and solvent mixtures comprising aromatic compounds with 1-4 rings, wherein the aromatic compounds have a molecular weight of about 150-400; and mixtures thereof.

46. The process of claim 40, wherein the resin is loaded with from about 5% by weight to about 60% by weight of the carbon and/or graphite fibers.

47 The process of claim 46, wherein the resin is an epoxy resin.

48. The process of claim 40, wherein the resin further comprises a second carbonaceous material selected from coke, graphite and conventional carbon fibers.

49. A method for enhancing the thermal and/or electrical conductivity of a polymeric resin, comprising incorporating into the resin a carbon fiber derived from a flash spinning mixture comprising about 55% to about 99% by weight of a carbonaceous pitch and about 1% to about 45% by weight of a flashing agent.

50. The method of claim 49, wherein the flashing agent is water.

51. The method of claim 49, wherein the spinning mixture further comprises up to about 4% by weight of a dispersing agent selected from rosins and tall oils.

52. A method for making a porous film, comprising: (a) providing a spinning mixture comprising a dispersion of an excess of a carbonaceous pitch in a flashing agent; (b) passing the spinning mixture from a high pressure region through an orifice to a low pressure region to form pitch fibers; (c) collecting the pitch fibers on a substrate heated to above room temperature to form a mat; and (d) further treating the mat to form a porous carbon or graphite film.
